(19) United States
(12) Patent Application Publication
(10) Pub. No.: US 2003/0206118 A1
(43) Pub. Date: Nov. 6, 2003

(54) Force transmitting sensor housing

(76) Inventors: Jeffrey E. Verkleeren, Belle Vernon, PA (US); Edward C, Nichols, Pittsburgh, PA (US)

Correspondence Address: BRINKS HOFER GILSON & LIONE, P.O. BOX 10395, CHICAGO, IL, 60611, US

(21) Appl. No.: 10/136,940

(22) Filed: May 2, 2002

(51) Int. Cl. G08G 1/01

(52) U.S. Cl. 340/933

(57) ABSTRACT

A sensor including a housing having a bottom surface defining a plane and an impact surface comprising a leading edge and a trailing edge. The leading edge is spaced from the plane at a first height while the trailing edge is spaced from the plane at a second height. Preferably, the second height is greater than the first height. The plane and the impact surface define tangents to a first arc having a first radius at a first location on the impact surface. The plane and the impact surface define tangents to a second arc having a second radius at a second location on the impact surface. Preferably, the second radius is greater than first radius. In one preferred embodiment, the first and second radii are between about 10 inches and about 26 inches. A system for monitoring traffic conditions is also provided, along with a method therefor.

### FIELD OF THE INVENTION

The present invention relates to a sensor for monitoring traffic information, and in particular to a sensor having a force transmitting housing, and methods for the use thereof.

### BACKGROUND

Sensors are often placed or positioned in a roadway to monitor traffic conditions and collect traffic information data. For example, sensors such as those disclosed in U.S. Pat. No. 5,408,179 can be positioned on a roadway to count the number of cars traveling thereon, to monitor the speed of the vehicles to collect other information about traffic conditions, such as temperature and pavement conditions. Such sensors, which typically are placed in the roadway, are frequently impacted by the vehicles traveling on the roadway, and are therefore subjected to relatively large impact loads. To absorb the loads of the impacting vehicles, the sensors are often provided with a housing having a leading end facing towards the oncoming traffic and a trailing end facing away therefrom. Often, the configuration of the housing, and in particular the leading end, can lead to stress concentrations, and may fail to provide an adequate load path from the initial point of impact to the pavement. For example, the leading end is often configured with one or more edges defining the first portion of the sensor housing impacted by the vehicle. Accordingly, these types of sensors may be susceptible to cracking and other types of structural damage.

### SUMMARY

By way of introduction, various preferred embodiments of the sensor described below include a housing having a bottom surface defining a plane and an impact surface comprising a leading edge and a trailing edge. The leading edge is spaced from the plane at a first height while the trailing edge is spaced from the plane at a second height. Preferably, the second height is greater than the first height. The plane and the impact surface define tangents to a first arc having a first radius at the leading edge. The plane and the impact surface define tangents to a second arc having a second radius at the trailing edge. Preferably, the second radius is greater than first radius. In one preferred embodiment, the housing does not penetrate the first and second arcs respectively.

In another preferred embodiment, a second impact surface extends from the leading edge of the first impact surface. The second impact surface has a leading edge spaced from the plane at a third height, wherein the third height is preferably less than the first height. The first and second impact surfaces form first and second obtuse angles with the plane respectively, with the first angle being greater than the second angle.

In one preferred embodiment, the plane and the impact surface define tangents to at least a first arc having a first radius at a first location on the impact surface. The plane and the impact surface also define tangents to a second arc having a second radius at a second location on the impact surface, wherein the second radius is greater than the first radius. Preferably, the first location is spaced from the second location. In one preferred embodiment, the first and second radii are both between about 10 inches and about 26 inches

Preferably, the sensor includes components capable of detecting traffic conditions, such as devices for counting the number of vehicles and measuring the speeds thereof. In one preferred embodiment, the sensor includes at least one magnetic detector.

In another aspect, a system for monitoring traffic conditions includes at least one sensor disposed in a roadway.

In yet another aspect, a method for monitoring traffic conditions includes disposing at least one sensor in a roadway, driving over the sensor with a first vehicle having a first tire with a first radius and impacting the impact surface of the sensor with the first tire, wherein the impact surface is substantially tangential to the first tire. The method further preferably includes driving over the sensor with a second vehicle having a second tire with a second radius greater than the first radius and impacting the impact surface of the sensor with the second tire, wherein the impact surface is also substantially tangential to the second tire.

The various preferred embodiments provide significant advantages over other sensors, traffic monitoring systems and methods of monitoring traffic. In particular, the impact surface is positioned such that it is the first surface impacted by the vehicle tire, which typically have a diameter of between about 20 inches and about 51 inches. In this way, the loads applied on impact are distributed evenly on the impact surface due to the elasticity of the tires. Moreover, the loads are not applied at a sharp edge, which can increase the stress concentrations in the housing.

The foregoing paragraphs have been provided by way of general introduction, and are not intended to limit the scope of the following claims. The presently preferred embodiments, together with further advantages, will be best understood by reference to the following detailed description taken in conjunction with the accompanying drawings.

### BRIEF DESCRIPTION OF THE DRAWINGS

FIG. 1 is a perspective view of a sensor.

FIG. 2 is a top, plan view of the sensor shown in FIG. 1.

FIG. 3 is a cross-sectional view of the sensor taken along line 3-3 of FIG. 2.

FIG. 4 is a side view of the sensor deployed on a roadway with

### DETAILED DESCRIPTION OF THE PRESENTLY PREFERRED EMBODIMENTS

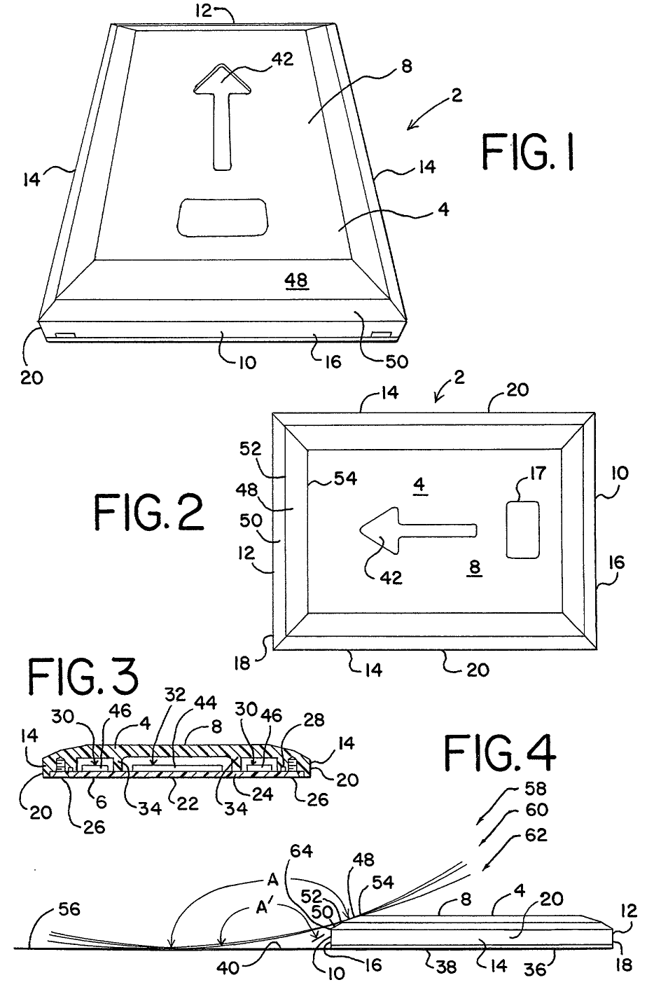

Referring to FIGS. 1-4, a sensor housing 2 includes an upper member 4 and a lower member 6. The upper member 4 has a top surface 8, a front end 10, a rear end 12 and opposite sides 14. Each of the front end, rear end and sides has a wall 25 16, 18, 20 forming a periphery of the housing. Preferably, the walls are substantially vertical, and have a height of about 0.40 inches measured from a bottom 22 of the sensor housing. Preferably, the front, rear and side walls 16, 18, 20 form a recess 24 in the bottom of the housing. The lower member 6 of the housing, or backplate, is received in the recess 24 and is secured to the upper 30 member 4 with fasteners 26. In alternative embodiments, the upper and lower members are secured by welding, bonding, snap fit, interference fit or other known devices. An o-ring 28, preferably made of silicon, or other gasket, is secured between the upper and lower members 4,6 to seal inner cavities 30, 32 formed therebetween. Preferably, a pair of longitudinal ribs 34 extend from the upper member and form three cavities 30, 32 between the upper and lower members 4, 6.

Preferably, the upper and lower members are made of an anodized aluminum alloy, preferably 6013 T6 or 6061 T6, although other materials, including other metals, hard plastic, epoxy, composite materials, and combinations thereof, would also work. Preferably, 316 stainless steel retaining screws (6-32) secure the lower member to the upper member. In one preferred embodiment, the overall length of the sensor is about 6.63 inches, the width of the sensor is preferably about 4.75 inches, and the weight of the sensor is about 1.78 lb. Of course, it should be understood that the overall dimensions and weight of the sensor can be varied without departing from the scope of this invention, and that the dimensions and weight are meant to be exemplary rather than limiting.

In one preferred embodiment, shown in FIG. 4, the sensor 2 further includes a rubber pad 36 secured to the bottom 22 of the housing, which is defined by the bottom surface of the lower member and the bottom of the walls forming the recess. Preferably, the rubber pad 36 is considered to be part of the housing, such that the bottom surface of the housing is defined as a bottom surface 38 of the pad 36 when installed thereon. Preferably, the pad has a thickness of about 0.063 inches, although greater and lesser thicknesses would also work.

As shown in FIG. 4, the sensor is disposed on top of a roadway surface 40. In one embodiment, a woven fabric adhesive (not shown), having a footprint greater than the housing, is disposed over the housing and is adhered to the top of the housing and the pavement surrounding the housing so as to secure the housing in place on the pavement. In one embodiment, the woven fabric is about 0.060 inches thick. In a preferred embodiment, the sensor is encapsulated in a plastic bag so that the adhesive engages the plastic bag rather than the housing itself. This arrangement facilitates the removal of the sensor, since the sensor is not adhered directly to the woven fabric.

In other embodiments, a cover, shaped to receive and mate with the outer surface of the sensor, can be disposed over the sensor as it rests on the pavement. For example, a rubber cover can be molded to mate with the sensor. The cover can be secured to the pavement with fasteners, adhesives or other types of fastening devices. In one alternative embodiment, straps can be passed through openings formed between the upper and lower housing members. The straps can then be secured to the pavement of the roadway, for example by nails or other mechanical devices. Various embodiments of a sensor and methods of attachment are further disclosed in U.S. Pat. No. 5,408,179, which is hereby incorporated herein by reference.

In one preferred embodiment, a plurality of sensors 2 can be deployed on a roadway, for example in adjacent lanes of a multi-lane expressway. As used herein, the term “plurality” means two or more. In addition, a plurality of sensors can be spaced longitudinally along a stretch of a roadway to collect information therealong. Preferably, the top surface 8 of the sensor includes directional indicia 42 to indicate how the sensor should be oriented relative to the direction of vehicle travel. For example, an arrow can be recessed into the top surface 8 of the upper member, the direction of which corresponds to the flow of traffic when the sensor is deployed in the roadway. Alternatively, other indicia, including words such as “front” and “rear,” can also be used. Preferably, a second recess 17 is also formed in the top surface of the upper member to accommodate a label, or other indicia, on which various information about the sensor can be provided.

It should be understood that the term “longitudinal,” as used herein, means of or relating to length or the lengthwise direction, and in particular the orientation of the sensor relative to the flow of traffic. The term “laterally,” as used herein means situated on, directed toward or running from side to side of the sensor, and transverse to the flow of traffic.

The sensor 2 has a detector system 44 housed in the cavity 32 formed between the upper and lower housing members. In one preferred embodiment, the detector system 44 includes lead and lag sensors, preferably comprising magnetic detectors spaced apart in the longitudinal direction. Analog signals from the detectors are converted to a digitized signals, which are applied to a microprocessor. The microprocessor includes a RAM memory, a real-time clock and input/output means for programming and up-loading data stored in the memory, and optionally a digital signal processor. Preferably, the sensor 2 includes one or more batteries 46, preferably about 3.6V, with the sensor having a power consumption of about 1.64 mA sleep, 5.5 mA awake and 42 mA RAM write. In a preferred embodiment, the batteries 46 are separated from the detector system, including the microprocessor, by the ribs 34. Pin connectors for communicating with the microprocessor are accessible from the rear end 12 of the sensor housing in the rear wall 18. Various components of the system are further described and disclosed in U.S. Pat. Nos. 5,408,179, 5,748,108 and 5,877,705, all of which are hereby incorporated herein by reference. In alternative embodiments, the sensor includes sensors and components for detecting temperature and precipitation data, which can be used to assess wet and icy conditions. In addition, the sensor can include transmission devices which can send various signals, for example signals indicating that a vehicle has passed over the sensor or that the sensor is functional. In other embodiments, the sensor can include a wireless data transmission device, such as a radio modem or cellular telephone, which transmits data and receives instructions from a remote controller, such as a personal computer. A plurality of sensors can be linked to a single controller, which collects data from all of the sensors.

In operation, the detector system 44 monitors the traffic conditions, and collects traffic information data. As used herein the phrase “traffic conditions” broadly means conditions on a roadway, including for example and without limitation, the number and speed of passing vehicles, and/or the temperature and status of precipitation on the roadway. The phrase “traffic information data” broadly means data collected as it relates to the traffic conditions, including for example and without limitation, the number, size and speed of passing vehicles, and information about the roadway, including for example and without limitation, information about the temperature thereof and precipitation thereon. For example, in one preferred embodiment, the detector system 44 monitors and counts the number of vehicles passing over the sensor 2, and also detects the speed and/or length of the passing vehicles.

Referring to FIGS. 1, 2 and 4, the sensor 2 has a first and second impact surface 48, 50 that transition between the front wall 16 and the top surface 8 of the sensor housing. The first impact surface 48 has a leading edge 52 and a trailing edge 54. The trailing edge 54 is formed at the junction of the first impact surface 48 and the top surface 8, while the leading edge 52 is formed at the junction of the second impact surface 50 and the first impact surface 48. It should be understood that in one preferred alternative embodiment, the second impact surface can be omitted altogether, such that the leading edge of the first impact surface is formed at the junction between the front wall and the impact surface. Conversely, the housing can be provided with more than two impact surfaces. The phrase “impact surface” is defined as the surface of the sensor housing that is first impacted, directly or indirectly, by a vehicle tire as it rolls over the sensor housing. It should be understood that various intervening layers, such as the woven fabric or plastic bag, may be interposed between the tire and the impact surface of the sensor housing, with the tire impacting the impact surface indirectly through or by way of the intervening layers. Preferably, the first and second impact surfaces 48, 50 are substantially flat, or planar, although it should be understood that they could also be curvilinear.

The leading edge 52 of the first impact surface is preferably positioned at a first height relative to the bottom surface 38 of the housing, and in particular a plane 56 defined thereby. It should be understood that the bottom surface 38 is defined as the bottommost surface of the housing interfacing with the roadway pavement 40, and can be defined by the bottom surface of the lower member, the bottom of the rubber pad, or any other material interposed between the pavement and the lower member. For example, in one preferred embodiment, the leading edge 52 of the first impact surface 48 is positioned at about 0.62 inches above the plane 56 containing the bottom surface 38, which is the same plane formed by the pavement 40 at that location.

The trailing edge 54 of the first impact surface 48 is positioned at a second height relative to the bottom surface 38 of the housing, and in particular the plane 56 defined thereby. In the preferred embodiment, the second height corresponds to the overall height of the sensor housing measured along the top surface 8 thereof. In one preferred embodiment, the second height is about 0.76 inches.

Preferably, the second height is greater than the first height such that the first impact surface 48 is angled upwardly and away from the oncoming vehicles, and forms an obtuse angle with the plane 56. Preferably, the first impact surface 48 is oriented, or angled, to minimize the transverse forces applied to the sensor 2 relative to the road as a vehicle tire impacts the first impact surface 48.

In particular, the impact load of the vehicle produces a force normal to the impact surface 48. The normal force is then transmitted to the roadway by way of a normal force vector and a transverse force vector, the latter of which tends to slide the sensor 2 along the roadway. The greater the normal force vector, the greater the amount of friction between the sensor 2 and the roadway 40 which resists the transverse force. In addition, the greater the normal force vector, the less the transverse force vector. Accordingly, it is desirable to maximize the angle (A) between the roadway surface 40 and the first impact surface 48, which in turn maximizes the normal force while minimizing the transverse forces. Theoretically, the optimum impact surface would be at 180°, although such a housing would not have a thickness.

The majority of passenger cars traveling on the roadways have a tire 58 diameter between about 23 inches and about 28 inches. The majority of trucks have a tire 62 with a diameter of between about 41 inches and about 51 inches. Accordingly, the range of tires typically impacting the sensor housing are between about 20 inches and about 52 inches. When referred to herein, the tires are considered to be perfectly circular, i.e., without any deformation or flattening, for example at the point of contact between the tire and the pavement or sensor impact surface, such that the entire periphery thereof is maintained at a constant radius from a central rotational axis.

Preferably, the first impact surface is oriented on the sensor 2 so as to be tangential to the impacting tire 58, 60, 62, while at the same time maximizing the angle (A) of the impact surface, taking into consideration the practical limitations on the height of the housing. In a preferred embodiment, a smaller diameter tire 58 impacts the first impact surface 48 at a position spaced closer to the leading edge 52 than the impact position of a larger diameter tire. Preferably, the impact surface 48 is oriented such that first and second tires 60, 62 of different diameters, preferably between about 20 and 30 inches, alternatively preferably between about 40 and 52 inches, and more preferably between about 20 and 52 inches, which form respectively first and second arcs tangential to the pavement and the plane 56 of the bottom of the sensor, are also tangential to the impact surface at first and second positions respectively at or between the leading edge 52 and the trailing edge 54.

For example, in one preferred embodiment, a first tire having a diameter of 20 inches impacts and is tangential to the first impact surface 48 at the leading edge 52 thereof, while a second tire having a diameter of about 51 inches impacts and is tangential to the first impact surface 48 at the trailing edge 54 thereof. Of course, it should be understood that tires having diameters of 20 and 51 inches respectively could impact the impact surface at locations spaced between the leading and trailing edges. Referring to FIG. 4, tires 58, 60, 62 having diameters of 24 inches, 36 inches and 51 inches respectively are shown as impacting the first impact surface 48.

Preferably, the first impact surface 48 is oriented such that it is the first surface contacted by the tire 58, 60, 62 as it rolls over the sensor housing. Accordingly, at the point of impact, preferably no other part of the housing 2 penetrates the arc defined by the tire.

In one preferred embodiment, the first impact surface 48 is formed at an obtuse angle (A) of about 163.17° relative to the plane 56 defined by the pavement 40 and the bottom of the sensor housing 38, which preferably includes a rubber pad, the height of the leading edge is preferably at about 0.62 inches from the plane and the height of the trailing edge is preferably at about 0.76 inches from the plane. This particular configuration maximizes the angle (A) of the impact surface, which reduces the transverse force vector. In addition, the first impact surface 48 distributes the load from the impacting tire to the ground by way of the upper member walls 16, 18, 20 and the pair of longitudinal ribs 34 that interact with the lower member 6. Of course, it should be understood that other angles, and first and second heights, would also work, depending on the overall height requirements for the sensor housing. In addition, the junctions between the various ribs and walls are preferably provided with transitional radii, which reduce the stress concentrations in the housing.

The second impact surface 50 is provided to accommodate tires having smaller diameters than those impacting the first impact surface 48. For example, the second impact surface 50 can be oriented to provide an initial impact surface for tires having a diameter of less than 20 inches. Since the second impact surface 50 is at a lesser obtuse angle (A′) relative to the plane 56, it does not penetrate, or otherwise impinge on, the arc defined by tires impacting the first impact surface 48. In one preferred embodiment, the leading edge 64 of the second impact surface 50 is about 0.46 inches, and forms an angle of about 146.18° relative to the plane 56 defined by the bottom of the sensor and/or the pavement.

Although the present invention has been described with reference to preferred embodiments, those skilled in the art will recognize that changes may be made in form and detail without departing from the spirit and scope of the invention. As such, it is intended that the foregoing detailed description be regarded as illustrative rather than limiting and that it is the appended claims, including all equivalents thereof, which are intended to define the scope of the invention.

What is claimed is:

1. A sensor for use in a roadway and capable of monitoring traffic conditions comprising:
a housing comprising a bottom surface defining a plane and an impact surface comprising a leading edge and a trailing edge, wherein said leading edge is spaced from said plane at a first height, wherein said trailing edge is spaced from said plane at a second height, and wherein said second height is greater than said first height, wherein said plane and said impact surface define tangents to a first arc having a first radius at said leading edge, wherein said plane and said impact surface define tangents to a second arc having a second radius at said trailing edge, and wherein said second radius is greater than said first radius.

2. The invention of claim 1 wherein said housing does not penetrate said first and second arcs respectively.

3. The invention of claim 1 wherein said impact surface comprises a first impact surface, and further comprising a second impact surface extending from said leading edge of said first impact surface, said second impact surface having a leading edge spaced from said plane at a third height, wherein said third height is less than said first height, wherein said first and second impact surfaces form first and second angles with said plane respectively, and wherein said second angle is less than said first angle.

4. The invention of claim 1 wherein said impact surface is substantially planar.

5. The invention of claim 1 wherein said first and second radii are between about 10 inches and about 26 inches.

6. The invention of claim 1 wherein said impact surface forms an angle of about 163.17 degrees with said plane.

7. The invention of claim 1 further comprising at least one magnetic detector disposed in said housing.

8. The invention of claim 1 further comprising a microprocessor disposed in said housing.

9. A sensor for use in a roadway and capable of monitoring traffic conditions comprising:
a housing comprising a bottom surface defining a plane and an impact surface comprising a leading edge and a trailing edge, wherein said leading edge is spaced from said plane at a first height, wherein said trailing edge is spaced from said plane at a second height, wherein said second height is greater than said first height, wherein said plane and said impact surface define tangents to at least a first arc having a first radius at a first location on said impact surface, wherein said plane and said impact surface define tangents to a second arc having a second radius at a second location on said impact surface, wherein said second radius is greater than said first radius, wherein said first location is spaced from said second location, and wherein said first and second radii are between about 10 inches and about 26 inches.

10. The invention of claim 9 wherein said housing does not penetrate said first and second arcs respectively.

11. The invention of claim 9 wherein said impact surface comprises a first impact surface, and further comprising a second impact surface extending from said leading edge of said first impact surface, said second impact surface having a leading edge spaced from said plane at a third height, wherein said third height is less than said first height, wherein said first and second impact surfaces form first and second angles with said plane respectively, and wherein said second angle is less than said first angle.

12. The invention of claim 9 wherein said impact surface is substantially planar.

13. A system for monitoring traffic conditions comprising:
at least one sensor disposed in a roadway, wherein said sensor comprises a housing comprising a bottom surface disposed on said roadway, wherein said bottom surface defines a plane, and an impact surface comprising a leading edge and a trailing edge, wherein said leading edge is spaced from said plane at a first height, wherein said trailing edge is spaced from said plane at a second height, and wherein said second height is greater than said first height, wherein said plane and said impact surface define tangents to a first arc having a first radius at said leading edge, wherein said plane and said impact surface define tangents to a second arc having a second radius at said trailing edge, and wherein said second radius is greater than said first radius.

14. The invention of claim 13 wherein said housing does not penetrate said first and second arcs respectively.

15. The invention of claim 13 wherein said impact surface comprises a first impact surface, and further comprising a second impact surface extending from said leading edge of said first impact surface, said second impact surface having a leading edge spaced from said plane at a third height, wherein said third height is less than said first height, wherein said first and second impact surfaces form first and second angles with said plane respectively, and wherein said second angle is less than said first angle.

16. The invention of claim 13 wherein said impact surface is substantially planar.

17. The invention of claim 13 wherein said first and second radii are between about 10 inches and about 26 inches.

18. The invention of claim 13 wherein said impact surface forms an angle of about 163.17 degrees with said plane.

19. The invention of claim 13 wherein said sensor comprises at least one magnetic detector disposed in said housing.

20. The invention of claim 13 wherein said sensor comprises a microprocessor disposed in said housing.

21. A method for monitoring traffic conditions comprising:
disposing at least one sensor in a roadway, wherein said sensor comprises a housing comprising a bottom surface defining a plane, and an impact surface comprising a leading edge and a trailing edge, wherein said leading edge is spaced from said plane at a first height, wherein said trailing edge is spaced from said plane at a second height, and wherein said second height is greater than said first height;
driving over said sensor with a first vehicle comprising a first tire having a first radius and impacting said impact surface with said first tire, wherein said impact surface is substantially tangential to said first tire; and
driving over said sensor with a second vehicle comprising a second tire having a second radius greater than said first radius and impacting said impact surface with said second tire, wherein said impact surface is substantially tangential to said second tire.

22. The method of claim 21 wherein said impact surface is a first portion of the sensor housing impacted by said first and second tires.

23. The method of claim 21 wherein said impact surface comprises a first impact surface, and further comprising a second impact surface extending from said leading edge of said first impact surface, said second impact surface having a leading edge spaced from said plane at a third height, wherein said third height is less than said first height, wherein said first and second impact surfaces form first and second angles with said plane respectively, and wherein said second angle is less than said first angle.

24. The method of claim 21 wherein said impact surface is substantially planar.

25. The method of claim 21 wherein said first and second radii are between about 10 inches and about 26 inches.

26. The method of claim 21 further comprising collecting traffic information data about said first and second vehicles as said vehicles travel over said sensor.

27. The method of claim 26 wherein said collecting traffic information data comprises counting said first and second vehicles.

28. The method of claim 27 wherein said sensor comprises at least one magnetic detector disposed in said housing.

29. The invention of claim 27 farther comprising a microprocessor disposed in said housing.
